(19) United States
(12) Patent Application Publication
(10) Pub. No.: US 2024/0001362 A1
(43) Pub. Date: Jan. 4, 2024

(54) Microfluidic device and method for isolating particles

(71) Applicant: BRAINDTECH S.p.A., Milano (IT)

(72) Inventors: Fabio Bianco, Milano (IT); Noemi Tonna, Milano (IT); Robert Lovchik, Milano (IT)

(73) Assignee: BRAINDTECH S.p.A., Milano (IT)

(21) Appl. No.: 18/367,569

(22) Filed: Sep. 13, 2023

Related U.S. Application Data
(63) Continuation-in-part of application No. PCT/EP2022/057184, filed on Mar. 18, 2022.

(30) Foreign Application Priority Data
Mar. 19, 2021 (IT) 102021000006731

(51) Int. Cl. B01L 3/00

(52) U.S. Cl. CPC B01L 3/502753; B01L 2400/0424

(57) ABSTRACT

If forms an object of the present invention a microfluidic chip (100, 200, 800, 900) for identifying and/or isolating small particles comprising at least a first microfluidic channel (110, 210), at least a first dielectrophoresis-producing electric field generating unit (DEP unit, 140, 240) positioned on a wall inside said channel (110, 210), at least one immunoaffinity capturing zone (150, 250) positioned inside said first channel (110, 210), on an opposing wall with respect to the one wherein said DEP unit (140, 240) is positioned and a voltage source (160, 260) electrically coupled to said DEP unit (140, 240), wherein said first channel (110, 210) includes a channel first end (112, 212) and a channel second end (114, 214) of a channel flow path for the fluid through the channel (110, 210). A further object is a method for the identification and/or isolation of small particles from a fluid sample comprising using the microfluidic chip according to the invention.

### BACKGROUND

Extracellular vesicles (EVs) are released from most cells under different physiological and pathological conditions and play a key role as biologically active mediators in intercellular communication. In recent years, scientific research has focused its attention on understanding the role of EVs, their involvement in the progression of several diseases, as well as their potential role as biomarkers in diagnosis, therapy, and in drug delivery system development.

EVs are identified in all bodily fluids (e.g., blood, urine, cerebrospinal fluid) and can cross multiple biological barriers.

There are 3 major classes of EVs: exosomes, microvesicles and apoptotic bodies, clearly differentiated by size, content, biogenesis, and biophysical properties:

i) Exosomes are small homogeneous vesicles (diameter 30-150 nm) which originate from the endosomal network implicated in the sorting of intraluminal vesicles to their proper destination, such as lysosomes or extracellular environment. Specifically, they are formed within multivesicular bodies (MVBs) which fuse with the plasma membrane in order to favor their extracellular release.

ii) Microvesicles shed from the plasma membrane of the cell of origin, they are quite heterogeneous in size (100 to 800 nm), bear selected cell-specific receptors and surface markers of the cell of origin and are characterized by a biochemical and molecular content which is dependent on the physiological and pathological conditions of the cell of origin.

iii) Apoptotic bodies are much larger (500 nm-4 μm) and are blebs which detach from a dying apoptotic cell as a result of increased hydrostatic pressure after cell contraction.

EVs express surface markers specific to the tissue and cell of origin and reflecting the tissue or cell's physiological state.

The increasing interest around EVs as potential source of diagnostic biomarkers has boosted the development of innovative solutions for their isolation and content analysis.

Ibsen et al., in ACS Nano, 2017, 11: 6641-6651 describe dielectrophoresis (DEP) to capture exosomes ad microvesicles from plasma. DEP is label-free, fast and accurate. However, the solution is not so specific: even if the electrodes would be coated with antibodies, it would be hard to avoid unspecific capturing due to strong clustering.

Yasukawa et al., in 2014: World Automation Congress, 1569887255, TSI Press, describe negative DEP manipulation, capturing cells on antibody coated regions between electrodes. US2019/039060 describes DEP manipulation applied to cells, wherein electrodes attract or push the cells toward the floor of a channel wherein said cells are moving, said electrodes being spotted on defined area in said channel. These two technologies are suitable for cells, which are one or two order of magnitudes larger than EVs.

Moreover, one of the main drawbacks of existing methodological approach consist in the difficult to distinguish, among the isolated EVs, EVs obtained from specific cells, wherein having a specific subset of EVs has been shown to be crucial to ensure effective use in the aforementioned applications.

The present invention relates to a device and a method for the isolation of particles, preferably of subsets of EVs, suitable for dealing with a limited amount of biological samples.

### DESCRIPTION

The present invention provides microfluidic systems, including components and uses thereof, for the isolation of particles utilizing a micro fabricated device or “chip”.

### BRIEF DESCRIPTION OF THE DRAWINGS

FIG. 1: schematic diagram of the microfluidic chip according to the present invention.

FIG. 2: an embodiment of a microfluidic chip according to the present invention A) prospective view; B) vertical section.

FIG. 3: three-step schematic diagram of a cross-section of a microchannel during operations A) sample fluid is fed; B) DEP is turned on; C) DEP is turned off.

FIG. 4: EVs are captured in the antibody coated region (A), not in the BSA coated one (B), exemplificative picture of fluorescence stained captured EVs.

FIG. 5: EVs are captured in the antibody coated region only in the presence of DEP (B), exemplificative picture of fluorescence stained captured EVs.

FIG. 6: N9 vesicles did not stick to CD144 antibody.

FIG. 7: EVs from microglial cell specifically isolated, exemplificative picture of fluorescence stained captured EVs.

FIG. 8: profile of the miRNAs extracted from MVs.

FIG. 9: schematic diagram of an embodiment of the microfluidic chip according to the present invention.

FIG. 10: schematic diagram of an embodiment of the microfluidic chip according to the present invention.

FIG. 11: schematic diagram of three different embodiments (A, B, C) of the microfluidic chip according to the present invention.

It is to be understood that the terminology used herein is for purposes of describing embodiments only and is not intended to be limiting since the scope of the present teachings will be limited only by the appended claims.

The defined terms are in addition to the technical and scientific meanings of the defined terms as commonly understood and accepted in the technical field of the present teachings.

As used herein, and in addition to their ordinary meanings, the terms “substantial” or “substantially” mean to within acceptable limits or degree to one having ordinary skill in the art.

As used herein, the terms “approximately” and “about” mean to within an acceptable limit or amount to one having ordinary skill in the art. The term “about” generally refers to plus or minus 15% of the indicated number. For example, “about 10” may indicate a range of 8.5 to 11.5. For example, “approximately the same” means that one of ordinary skill in the art considers the items being compared to be the same.

In the present disclosure, numeric ranges are inclusive of the numbers defining the range.

As used in the specification and appended claims, the terms “a,” “an,” and “the” include both singular and plural referents, unless the context clearly dictates otherwise. Thus, for example, “a channel” includes one channel and plural channels.

As used herein, the term “microfluidic environment” means a substrate including networks of channels having dimensions from few (eg. 4-5 μm) to hundreds of microns. The channels are configured to flow, manipulate, and otherwise control fluids in the range of microliters to picolitres.

A “channel,” as used herein, means a feature on or in an article (substrate) that at least partially directs flow of a fluid. The channel can have any cross-sectional shape (circular, oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length except for its inlet(s) and/or outlet(s).

A “DEP unit” means a set of electrodes. In an embodiment, a DEP unit comprises between 2 and 20 electrodes. In extreme cases of upscaling, a DEP unit comprises even more than 20 electrodes. In an embodiment, the width of a single electrodes comprised in the DEP unit is between 5 and 100 micrometers.

“Immunoaffinity capturing zone” means a surface capable to specifically binds one or more subset of particles, wherein said surface is covered with antibodies, thus allowing antibody-antigen binding, and/or with Biotin-Avidin-System or other type of bioreaction amplification systems, i.e. interactant couples similar to biotin-streptavidin like i.e. Avidin, Streptavidin, NeutrAvidin and CaptAvidin Biotin-Binding Proteins and Affinity Matrices like i.e. Protein A/G Protein A, Protein G and Protein L.

“Particles” means a small volume of material. In this context, a particle has a maximum dimension of about 800 nm. In an embodiment, reference is made to biological particles. In a preferred embodiment, said biological particles are vesicles.

For the purpose of this description, all of the vesicles are extracellular vesicles (EVs) and these are classified as follows:
small EVs (sEVs), with dimensions below 200 nm or below 300 nm.
medium/large EVs (m/I EVs), with dimensions ranging from 200 or 300 nm to 800 nm.

Microfluidic apparatuses are provided for separating particles. Said apparatuses generally comprise a chip comprising at least a channel including a first end and a second end, i.e., an inlet and an outlet.

As one aspect of the present invention, a microfluidic apparatus (e.g., a microfluidic chip) is provided that efficiently isolates a subset of particles, preferably a subset of EVs, from a stream of an aqueous fluid. The microfluidic apparatus according to the present invention facilitates full and specific separation of said subset of particles.

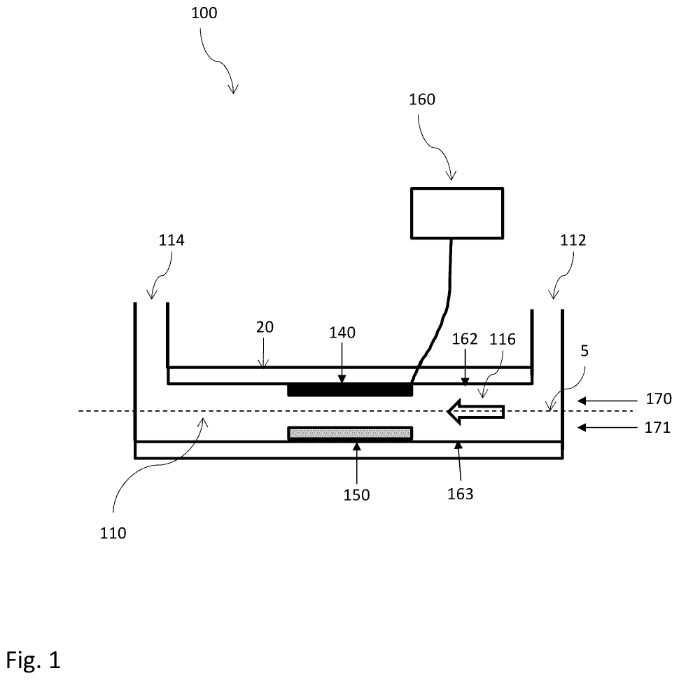

FIG. 1 schematically illustrates a microfluidic apparatus according to the present invention. Said microfluidic apparatus 100 comprises a first microfluidic channel 110, a first DEP unit 140, an immunoaffinity capturing zone 150 and a voltage source 160 electrically coupled to the DEP unit 140.

Said microfluidic channel 110 comprises a channel first end 112 (i.e., channel inlet) and a channel second end 114 (i.e., channel outlet) of a channel flow path for the fluid through the channel 110, represented by arrow 116. For example, the fluid enters the channel 110 at the channel first end 112, flows through the channel 110, and exits the channel 110 at the channel second end 114.

Perpendicular to the flow 116, in said microfluidic channel 110 are defined two portions: an upper portion 170 and a lower portion 171. The internal surface of said channel 110 is defined ceiling 162 in the upper portion 170 and floor 163 in the lower portion 171.

Said first DEP unit 140 extends along said ceiling 162 inside said channel 110. In a preferred embodiment, said DEP unit 140 extends over said ceiling 162 for almost all of the length of the channel 110 itself.

Said ceiling has a length, corresponding to the length of the channel, and a width.

Said at least one DEP unit extends in a continuous topography along said ceiling, wherein “in a continuous topography” means that the electrodes constituting said at least one DEP unit cover in a continuous manner said ceiling, without any leaving any gap among each other.

In an embodiment, said at least one DEP unit extends along said ceiling covering at least 80% of its length, or at least 90%, or at least 100%, where the portion of said ceiling not covered by said at least one DEP unit is intended a portion proximal to the inlet and/or to the outlet of the channel, the portion covered by said at least one DEP unit being continuous.

In an embodiment, said DEP unit is centered on said ceiling, covering at least 50% of its width, or at least 60%, or at least 70%. The here described geometry allows the formation of long uniform electric fields oriented the same way as the flow direction 116 in the channel 110.

Said immunoaffinity capturing zone 150 extends along said floor 163 inside the channel 110.

In this embodiment, the DEP unit and the immunoaffinity capturing zone are located opposite each other in said channel 110, wherein the DEP unit is in the upper portion 170 and the immunoaffinity capturing zone in the lower portion 171.

The channel inlet 112, serving to receive the fluid sample, in an embodiment has a cross section comprised between 100 μm and 1 mm to facilitate the introduction of the fluid sample.

The channel inlet may communicate with the channel. Namely, the fluid sample introduced to the channel inlet may flow in and along the channel.

The channel may be connected to the channel inlet. The channel may provide a movement path allowing the sample introduced to the channel inlet to pass there through. The channel may be provided to allow the fluid sample to move to an outlet unit.

The fluid sample moves by using a capillary force, pressure, and/or a centrifugal force as power within the channel.

The channel is, for example, a microfluidic channel. The microfluidic channel may refer to a channel in which the sample moves or flow according to a capillary action.

The microfluidic apparatus 100 comprises substrate 20, which may be one or more substrates associated with one another to define fluid channels there between. In one embodiment, substrate 20 comprises an insulating (e.g., glass or polymer), or a semiconductor (e.g. silicon structures) in which various features (e.g. channels, inlet, outlet) of the device 100 are designed. Such features can be made by forming those features into a surface and/or a subsurface structure of substrate 20 using microfabrication techniques known to those skilled in the art.

In an embodiment, said channel is obtained overlapping two substrates, as an example, a PMDS substrate and/or glass. In this embodiment, the microfluidic chip comprises channels facing downwards. The microfluidic chip is overlapped to a PDMS disc, so that the channels are formed. In this embodiment, the immunoaffinity capturing zone is on the PDMS disc, which is conveniently functionalized, the DEP unit is on the microfluidic chip, or vice versa.

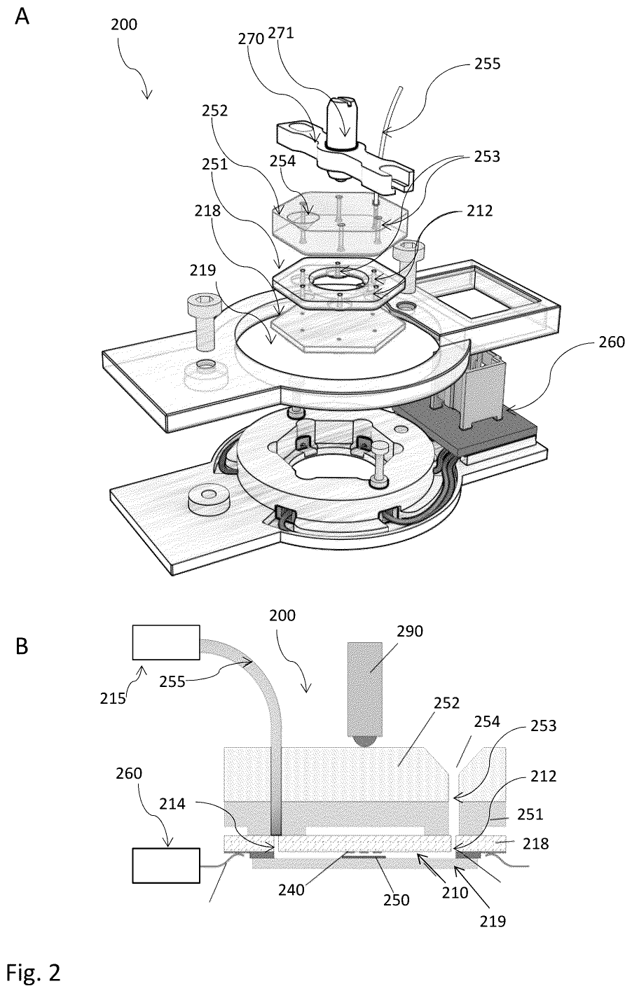

As an example, according to FIG. 2A, B, the microfluidic apparatus 200 comprises a hexagonal microfluidic chip 218 overlapped to a PDMS disc 219. The overlapping between the microfluidic chip 218 and the PDMS disc originates channels 210, in this specific embodiment 8 channels are originated. At least a DEP unit 240 is positioned on the wall inside said channel 210 on said microfluidic chip 218, at least an immunoaffinity capturing zone 250 is positioned on the PDMS disc, therefore resulting inside the channel 210, on an opposing wall with respect to the one wherein said DEP unit 240 is positioned. The microfluidic apparatus further comprises a voltage source 260 electrically coupled to the DEP unit 240.

The channel 210 includes a channel first end 212 (i.e., channel inlet) and a channel second end 214 (i.e., channel outlet) of a channel flow path for the fluid through the channel 210. In this embodiment, the channel outlet 214 is connected to an outlet unit 215.

In this embodiment, exemplificative and not limitative of the present invention, a gasket 251, preferably made in PDMS, is positioned above said microfluidic chip 218. On the top of said gasket 251, is positioned a pressing piece 252. On said gasket 251 and on said pressing piece 252 there are connecting channels 253, through which is inserted as an example a capillary tube 255 connecting the cannel 210 to the external environment or to the outlet unit 215. In this embodiment, the gasket allows a perfect seal of the chip sealing. The pressing piece 252 exerts a slight force, aimed at maintaining the closure of the chip and comprise a region comprising the funnel 254 for the loading of the sample.

In this embodiment, a screw fixing bridge 270, 271 is mounted on the top of said pressing piece 252, to keep the sandwich correctly in place.

The device should work either in pulling and in pushing mode. However, the pulling mode is preferred, reducing delamination.

In an embodiment, the microfluidic apparatus is a multiplexing with parallel channels.

In this embodiment, a microfluidic apparatus comprises a channel fed through an inlet, where said channel splits into multiple channels, for example it is splitted into two, or three, or four, or five, or six parallel channels. At least a first DEP unit extends along the ceiling of each one of said parallel channels, each one of said DEP unit in said parallel channels being controlled independently from each other. An immunoaffinity capturing zone extends along the floor of each one of said parallel channels. Each one of said parallel channels include a channel second end.

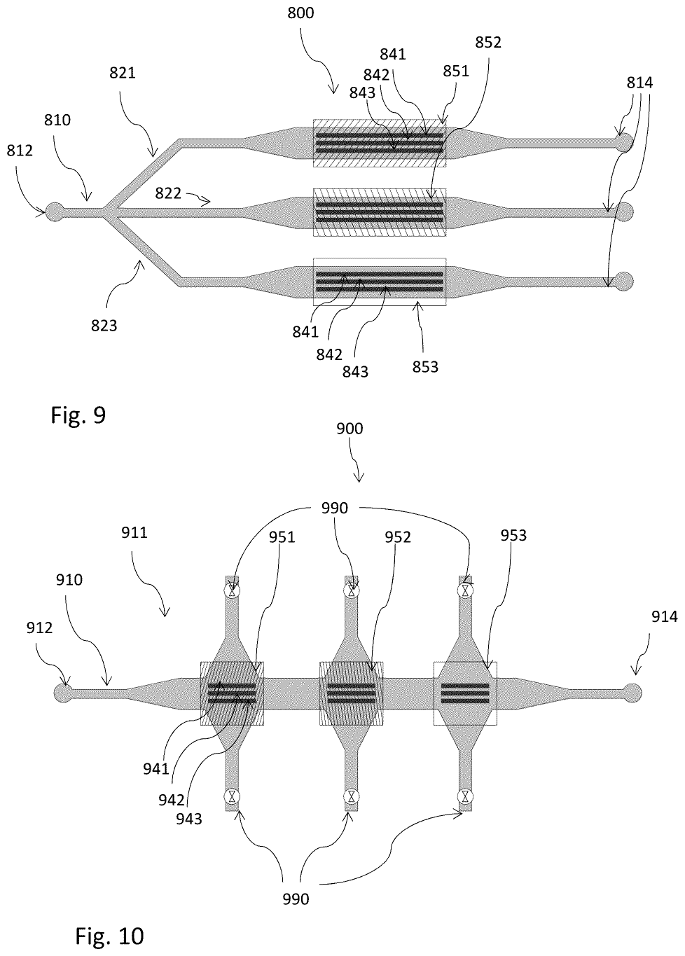

In FIG. 9 is schematically represented an embodiment: a microfluidic apparatus 800 comprises a channel 810, fed through the inlet 812, splitting into three channels 821, 822, 823. A DEP unit comprising three electrodes 841, 842, 843 extends along the ceiling of each one of said parallel channels. An immunoaffinity capturing zone 851, 852, 853 extends along the floor of each one of said parallel channel. Each one of said multiple channels comprises a channel second end 814.

Said electrodes 841, 842 and 843 generates the long uniform electric field in between them.

In this embodiment, as an example, EVs of different origin are captured specifically in each flow path using different antibodies in each one of the immunoaffinity capturing zones 851, 852, 853, wherein each fluidic path leads to a separate outlet 814 for specific recovery of the EVs subset.

In an embodiment, the microfluidic apparatus is a multiplexing 900 with sequential DEP electrode arrays and immunoaffinity capturing zones.

In this embodiment, the single channel comprises more sections along the fluid direction. In each one of said sections is comprised at least a DEP unit along the ceiling and an immunoaffinity capturing zones along the floor. Each one of said DEP units is controlled independently from each other. Each one of the sections into which the channel is divided has a valve for specific recovery of the EVs subset.

With reference to the embodiment represented in FIG. 10, the channel 910, fed through the inlet 112, comprises three sections. A DEP units comprising three electrode 941, 942, 943 extends along the ceiling of each one of the sections. Immunoaffinity capturing zones 951, 952, 953 extends along each one of said sections.

In this embodiment, as an example, EVs of different origin are captured specifically in each flow path using different antibodies in each one of the immunoaffinity capturing zone 951, 952, 953, wherein each fluidic path leads to a distinct valve 990 for specific recovery of the EVs subset.

Reagents 5 flow from inlets 112, 812, 912 into the channel 110, 810, 910 and then exit through outlet 114, 814, 914. Between the time the fluids enter said channel, the fluid is subjected to DEP in a direction perpendicular to the flux. Therefore, particles comprised in said fluid are prompted toward the immunoaffinity capturing zone and the recognized particles bind to the same.

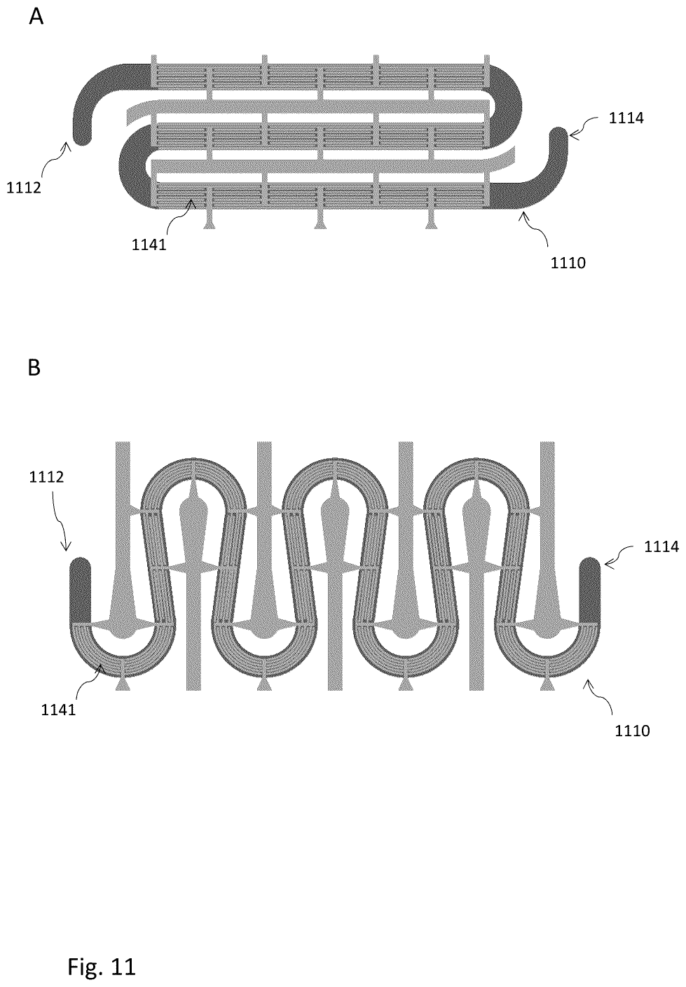

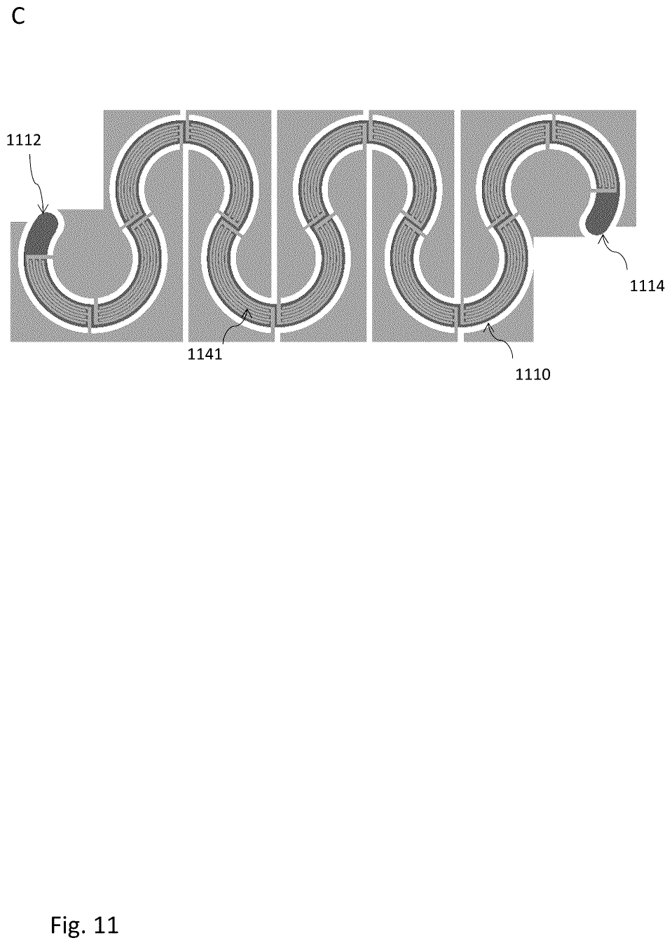

In an embodiment, represented in FIG. 11, the electrodes belonging to said DEP unit might have a slight angle or curvature along the channel, in order to follow the flow path. The coverage of at least 80% of the channel enables longer interaction times of the vesicles. The channel 1110, fed through the inlet 1112, is curved along its length. The sinus flow path has been demonstrated to increase the capture area. The absence of right angles avoids the formation of clogging into the channel.

The DEP units 1141 on the ceiling of said channel are connected each other, to form a continuous electrode along the flow path.

In the embodiment depicted in FIG. 11B, 110, the DEP units are curved, too.

At the beginning, the system is filled with liquid (mostly a passivation liquid, such as a physiological buffer containing bovine serum albumin) until it is found in the loading area. Then the fluid sample is added.

Preferably, the fluid sample in which particles to be isolated are suspended is an aqueous composition comprising 20-200 mM NaCl, 0.1-10 mM KCl, 0.1-10 mM Na2HPO4, and 0.1-6 mM KH2PO4, Hepes mM and Sucrose 50-450 mM. In an embodiment, said buffer further comprises glucose (0-100 mM), MgCl2 0-20 mM, NaCl 0-200 mM, KCl 0-40 mM, BSA 0-5% (p/V) Said buffer has been demonstrated to allow a correct handling of the microvesicles inside the microfluidic flux, in order to apply the specific DEP force and favor the deflection of the particles to the capture zone.

In an embodiment, said DEP is applied with a Current intensity (I) comprised between 0.1-20.0 V (preferred working range), at a Frequency (W) comprised between 0.1-20 MHz (preferred working range).

In an embodiment, said DEP is applied with a Current intensity (I) comprised between 0.1-6.0 V (preferred working range), preferably between 1 and 5, still more preferably between 1.5 and 4.5 V at a Frequency (W) comprised between 0.1-5 MHz (preferred working range), preferably between 1 and 4.5, or between 1.5 and 4 MHz.

In an embodiment, the function of the electric field is either a square function or a sinus function with operating alternating current between 500 kHz and 20 MHz and peak to peak voltages between 3 and 20 Volts.

The fluid flow preferably at a flow rate from 0.1 to 5 μI/min (Preferred working range), or between 1 and 4, or between 2 and 4 μI/min. In a preferred embodiment, wherein said particles are EVs, negative DEP in the range of 0.1 MHz to 20 MHz with peak-to-peak voltages between 3 and 10 V pushes the EVs towards the antibody coated surface. The EVs are forced to interact with the surface, slow down and “roll” over the antibodies, sticking to the surface if antibody binding takes place. The methods generally comprise flowing a fluid which is an aqueous medium comprising small particles through at least one channel. The methods further include subjecting the fluid to an electric field gradient. Said electric field is generated by at least one DEP unit that is affixed to a channel wall, to apply a negative dielectrophoretic force to said small particles, wherein said force pushes the small particles towards the opposing wall of said channel. Said opposing wall of the channel is an immunoaffinity capturing zone.

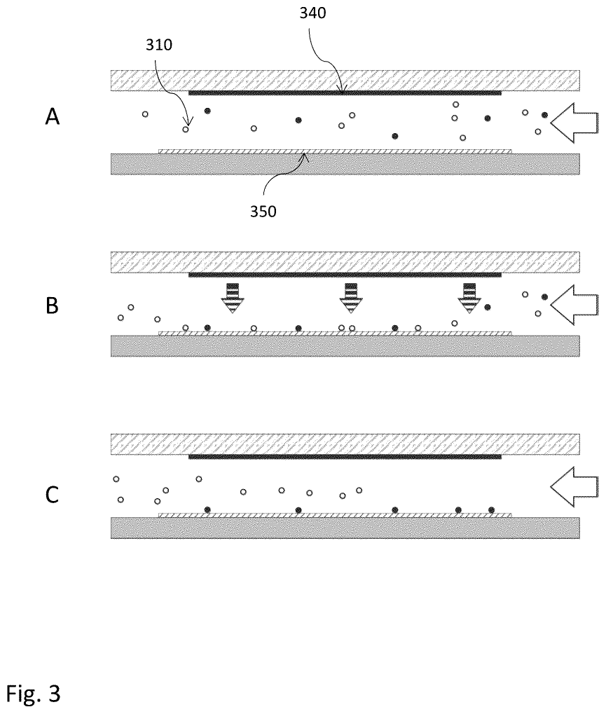

FIG. 3 describes the microfluidic chip in operation. In panel A, the fluid sample (white arrow) is uploaded into the chip and fills the channel 310. DEP 340 is turned on, (black arrows in panel B), and particles are forced to move versus the immunoaffinity capturing zone 350. Finally, panel C, the DEP is turned off, and particles specifically biding to the immunoaffinity capturing region remain trapped, wherein the fluid sample continues to flow from the inlet to the outlet of the channel.

Preferably, said small particles are vesicles. Vesicles generally comprise any cell-derived or no cellularly derived particle that is defined by a lipid envelope. Vesicles may include any suitable components in their envelope or interior portions. Suitable components may include compounds, polymers, complexes, mixtures, aggregates, and/or particles, among others. Exemplary components may include proteins, peptides, small compounds, drug candidates, receptors, nucleic acids, ligands, and/or the like. Preferably, said small particles are EVs.

In a mixed population of EVs, all EVs are forced to touch said opposite surface rolling, hopping, sliding, but only the EVs of interest, i.e., the EVs recognizing said antibodies on said immunoaffinity capturing zone, undergo a specific binding with the antibodies.

The antibodies on said immunoaffinity capturing zone are advantageously specific antibodies against a selected protein predominantly expressed in the cells or tissue of interest. This cell-specificity on one side enables cell-specific EVs to be isolated, and on the other side delivers a cell-specific element for analysis.

In a further embodiment, on said immunoaffinity capturing zone avidin and biotin conjugate complexes are spotted.

The DEP unit is then turned off, and a rinsing solution is fluxed inside the channel. Unspecifically bound EVs are flushed out of the channel and the specifically bound EVs remain on the antibody coated surface.

Advantageously, the geometry of the here described system allows to apply a gentle electrophoretic field for a long time, wherein the electrodes of the DEP units are distributed along the ceiling of the entire channel. In a preferred embodiment, the method according to the present invention is used to separate particles that are medium/large EVs. The size of the particle determines its charge potential, directly related to the DEP required to move the same

The here provided geometry of the system exposes the particles in the fluid to an electric field for a long time, i.e., for the time required to the particle to move from the inlet to the outlet the particle itself is pushed and slowed down to bring it in contact with the capturing zone.

The electrical field exerted on the particles is sufficient to force the particles themselves to move toward the immunoaffinity capturing zone without impacting their nature. A stronger electrical field, applied for a shorter time, would let said particles to burst.

### Examples

Methods:

Cell Cultures and In Vitro Stimulation

N9: murine microglial cells were seeded at the density of 20,000 cells/cm2 on poly-L-Lysine (0.1 mg/ml in DW) pre-coated plate and cultured overnight.

Primary rat microglia: cells were obtained from P2 new-born Sprague Dawley rats (Envigo srl) at 17-18 DIV. Briefly, 500,000 cells/w were seeded in 6 well-plate (50,000cells/cm2) poly-L-Lysine (0.1 mg/ml in DW) pre-coated and cultured overnight.

Challenge for Microglia Cells

After 24 h of culturing, cells were gently washed with Krebs-Ringer Hepes (KRH) solution (125 mM NaCl, 5 mM KCl, 1.2 mM KH2PO4, 2 mM CaCl2), 1.2 mM MgSO4, 25 mM 4-(2-hydroxyethyl) piperazine-1-ethanesulfonic acid (HEPES) and 6 mM glucose) and stimulated to promote MVs secretion with 2 mM ATP (Sigma Aldrich) for 30 min in KRH solution (60 μl/cm2)

After 30 minutes, KRH was collected in an appropriate tube and subjected to differential centrifugations at 4° C. for defining the pellet containing the EVs to be inserted into the microfluidic device for isolation.

Human Dermal Microvascular Endothelial Cells [HMVEC, Lonza, #LOCC-2543; lot. 0000440546] were seeded and cultured in EGM-2M endothelial medium (Lonza) as indicated from data sheet.

Challenge for Endothelial Cells

To isolate EVs from HMVEC, cells were incubated with TNF-α 10 ng/ml for 18 h before EVs collection from the cells supernatant.

EVs Isolation

This protocol allows to isolate, in a non-specific manner, all the EVs present in the supernatant of a fluid biological sample under analysis.

Conditioned KRH was collected and pre-cleared from cells and debris at 300×g for 15 min at RT. Supernatant is collected and transferred in another tube.

In order to better purify sample from debris and membrane remnants the supernatant obtained from the first centrifuge goes through another centrifugation step: 1200 g×15 min. at 4° C. The supernatant is collected.

EVs were then pelleted from the supernatant by a centrifugation step at 16,000×g for 30 min at 4° C.

After the vesicles EVs spin down, collected EVs were suspended in 50% MicroCATCH buffer (25 mM MgCl2, 5 mM Glucose, 250 mM HEPES, 12 mM KCl), 25% water and 25% BSA at 4%.

The so obtained suspension is the fluid sample which is uploaded into the chip according to the present invention to isolate a specific subgroup of EVs.

EV Membrane Staining

Isolated EVs were stained with FITC-CFSE staining (Life Technologies) or Yellow CellTrace CFSE (Life Technologies) to allow the detection of all the EVs in the samples. The probes are selected being them able to cross the plasma membrane and covalently binds aspecifically free amines on the surface and inside cells or vesicles.

Samples were suspended in a final volume of 500 μL of CSFE in PBS w/o MVs (20 μL VCT 50 μM+480 μL PBS— final CSFE concentration: 2 μM) and incubated at 37° C. for 45 min protected from light, and gently mixed every 10 min, according to the literature.

Unbound dye was removed with a wash by adding to the EVs sample a small volume of PBS or KRH buffer (i.e., 500-700 μl). Stained EVs was isolated at 16,000 g×30 min at 4° C.

### Example 1: Assembling a Device According to an Embodiment of the Present Invention

With reference to FIG. 2, hexagonal shaped microfluidic chips comprising electrode arrays for DEP and SU-8 channels are placed in a 3D printed device. The channels are facing downwards. The chip is a glass chip patterned with metal electrodes (Ti: 5 nm, Pd: 100 nm).

A PDMS disc (approx. 1 mm thick) is placed onto the chip after assembly to close the channels. This PDMS disc is functionalized with antibodies.

A gasket and pressing piece as well as a bridge with a resilient pressure piece are used to align and leak free connection of capillaries to the chip.

Visualization of the sample inside the chip is allowed from the bottom using an inverted microscope (290 in FIG. 2B).

In this embodiment, the chip work in pulling mode, therefore reducing the chance of the PDMS delaminating from the chip.

### Example 2: Antibody Coating and BSA Passivation

PDMS discs described in Example 1 were incubated with antibody solutions for at least 1 hour at 37° C.

PDMS slabs were used to protect areas from the antibody solutions. After rinsing with water, the protecting PDMS was removed, and the discs rinsed a second time with water and dried under a stream of nitrogen.

The uncoated areas were passivated by using a 4% BSA solution for the initial filling of the chips.

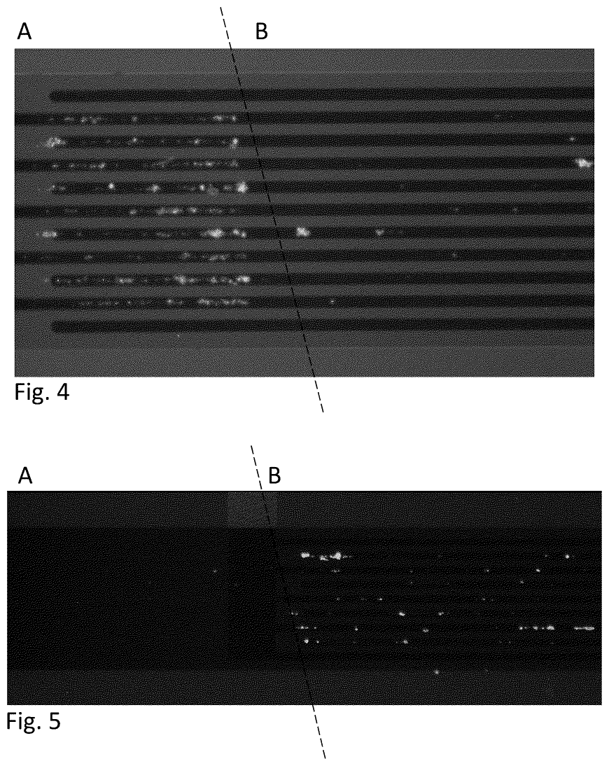

As shown in FIG. 4, exemplificative of several experimental sessions, efficient EVs capturing was observed on the antibodies (area A) and hardly any capturing on the BSA (area B). In the here presented experiment, the DEP parameters were as follows: 2 MHz square, 4.5 V.

The fluid flow was 0.025 μI/min

As an example, conveniently used antibody mixtures are as follows:

Antibodies for Microglia EVs capture:
anti-CD11 b extracellular antibody (Life technologies);
anti-TMEM119 extracellular antibody (Abcam);
anti-Iba1 extracellular antibody (Life Technologies).

Antibodies for Endotelial EVs capture:
anti-CD144 extracellular antibody (Life technologies);
anti-CD62E extracellular antibody (Life technologies);
anti-CD31 extracellular antibody (Life technologies);
anti-CD106 extracellular antibody (Life Technologies).

The final concentration of the mixtures is 15 μg/ml.

### Example 3: DEP Effect Evaluation

A fluid sample obtained as detailed in the paragraph EVs isolation, comprising N9 microvesicles, was uploaded into the chip exemplified in Example 1.

In a first step, DEP was off and the microvesicles flow into the center of the channel height, without being captured on the antibody coated surface (FIG. 5A).

In a second step, DEP was turned on and microvesicles were captured on the immunoaffinity capturing zone, which is coated with TMEM119 antibody (FIG. 5B).

This indicates that DEP is needed to bring the microvesicles into contact with the surfaces.

Working settings: 2 MHz square, 5.5 V, flow 0.01 μl/min, MicroCATCH buffer.

### Example 4: Cell Specific EVs Isolation

A chip with two different immunoaffinity capturing zone was prepared. A first zone was free of any antibody, a second zone comprises CD144 antibody. A fluid sample comprising N9 microvesicles was uploaded into the microfluidic chip.

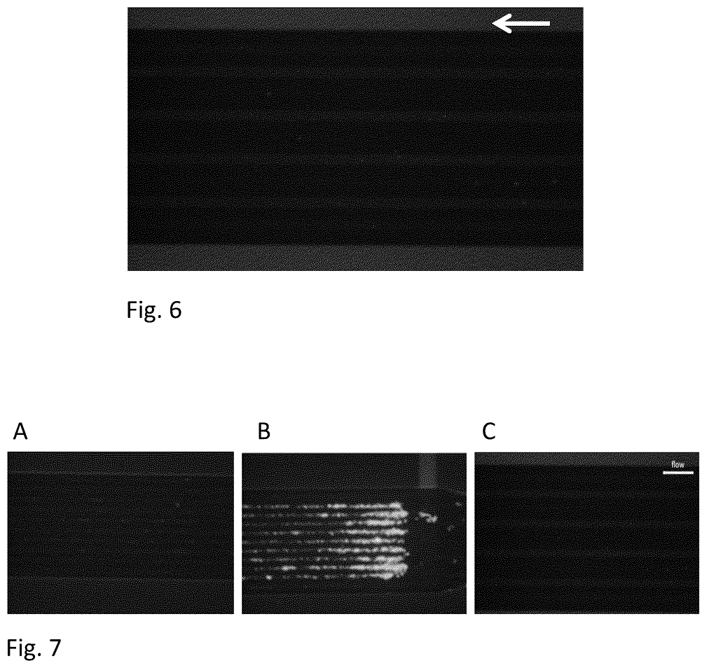

Working settings were as follow: 2 MHz square, 5.5 V, flow 0.01 μl/min, MicroCATCH buffer. N9 vesicles did not stick to CD144 (FIG. 6). The experiment ran for more than half an hour. A few sticking events (less than 10) were observed. Vice versa, MVs specifically bound in the immunoaffinity capturing zone with the N9 specific Ab mix (FIG. 6B).

### Example 5: Cell Specific EVs Isolation

A chip according to the present invention comprising three different immunoaffinity capturing zones was prepared. On a first zone (FIG. 7A), no antibody was present. In a second zone (FIG. 7B) there was the TMEM119 Ab, in a third zone (FIG. 7C), there was CD144. The chip has been uploaded with a fluid sample containing endothelial vesicles and microglial vesicles.

FIG. 7 is a representative picture showing microglia MVs (type 1) isolated following DEP in TMEM119-positive capture region (FIG. 7B). When DEP is applied to the same fluid sample in a capture region coated with endothelial marker CD44 (FIG. 7C) no microglial vesicles are captured. In this same region, observing a different fluorescent channel, endothelial vesicles stained has above indicated are captured by the CD144 antibody (data not shown)

### Example 6: Molecular Analysis on Isolated Cell Specific MVs

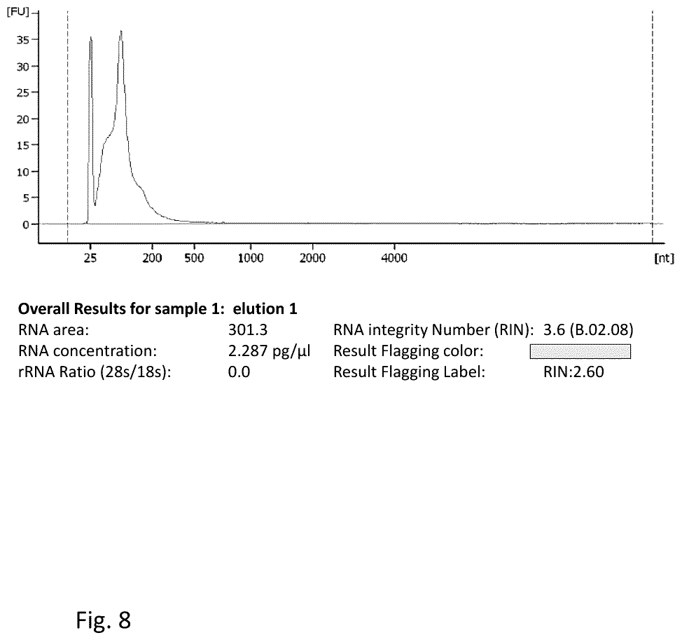

The MVs isolated according to example 5 are processed for subsequent biochemical and molecular analysis. FIG. 8 reports the peak of miRNA extracted from microglia MVs.

1. A microfluidic chip (100, 200, 800, 900) for identifying and/or isolating small particles comprising at least a first microfluidic channel (110, 210, 1110), at least a first dielectrophoresis-producing electric field generating unit (DEP unit, 140, 240, 1140), at least one immunoaffinity capturing zone (150, 250) and a voltage source (160, 260) electrically coupled to said DEP unit (140, 240), wherein said first channel (110, 210, 1110) comprises a channel first end (112, 212, 1112) and a channel second end (114, 214, 1114) of a channel flow path for the fluid through the channel (110, 210, 1110), in said microfluidic channel (110, 210, 1110) are defined two portions: an upper portion (170) and a lower portion (171), wherein the internal surface of said channel (110, 1110) is defined ceiling (162) in the upper portion (170) and floor (163) in the lower portion (171), wherein said immunoaffinity capturing zone (150, 250) extends along said floor (163) inside the channel (110, 1110),
characterized in that
said at least first DEP unit (140, 240, 1140) extends continuously along said ceiling (162) inside said channel (110, 1110) covering at least 80% of the length of the channel itself, or at least 90%.

2. The microfluidic chip according to claim 1, wherein said at least one DEP unit is centered on said ceiling, covering at least 50% of its width, of at least 60%, or at least 70%.

3. The microfluidic chip according to claim 1, wherein said at least one DEP unit (140, 240) generates a non-uniform electric field for a continuous portion covering at least 80%, or at least 90% of the length of the channel.

4. The microfluidic chip according to claim 1, comprising a substrate 20, consisting in one or more substrates associated with one another to define fluid channels there between.

5. The microfluidic chip according to claim 1, wherein said channel (1110) is curved along its length.

6. The microfluidic chip according to claim 1, wherein said at least one DEP unit is curved.

7. The microfluidic chip according to claim 1, wherein said microfluidic channel (810) having a first end (812) splits into multiple channels (811, 812, 813), each one of said multiple channels (821, 822, 823) comprising one or more independent DEP unit and at least one immunoaffinity capturing zone (851, 852, 853) on an opposing wall with respect to the one wherein said DEP units are positioned, each one of said multiple channels (821, 822, 823) including a channel second end (814).

8. The microfluidic chip according to claim 1, wherein said microfluidic apparatus is a multiplexing with sequential DEP units and immunoaffinity capturing zones (951, 952, 953) arranged linearly along a single channel (910), comprising a first end (912) and a second end (914) and valves (990) at the exit of each one of said capturing zone (951, 952, 953).

9. A method for identifying and/or isolating small particles from a fluid sample comprising using the microfluidic chip according to claim 1.

10. The method according to claim 9, comprising:
injecting a fluid sample into the inlet unit;
generating a non-uniform electric field perpendicular to the direction of the main channel with the dielectrophoresis producing electrode causing particles in the sample to be subjected to dielectrophoresis moving towards the immunoaffinity capturing zone;
let target particles binding specifically on said immunoaffinity capturing zone.

11. The method according to claim 9, comprising injecting the fluid sample into the inlet unit, wherein said fluid is an aqueous composition comprising 20-200 mM NaCl, 0.1-10 mM KCl, 0.1-10 mM Na2HPO4, and 0.1-6 mM KH2PO4, Hepes 10-500 mM, sucrose 50-450 mM, glucose 0.1-100 mM, MgCl2 0.1-20 mM, NaCl 0-200 mM, KCl 0.1-40 mM, BSA 0.1-5% (p/V).

12. The method according to claim 9, wherein DEP is applied with a Current intensity (I) comprised between 0.1-20.0 V, at a Frequency (W) comprised between 0.1-20 MHz.

13. The method according to claim 9, wherein said fluid flows at a flow rate from 0.1 to 5 μl/min.
